(19) United States
(12) Patent Application Publication
(10) Pub. No.: US 2016/0381001 A1
(43) Pub. Date: Dec. 29, 2016

(54) METHOD AND APPARATUS FOR IDENTITY AUTHENTICATION BETWEEN SYSTEMS

(71) Applicant: LeCloud Computing Co., Ltd., Beijing (CN)

(72) Inventor: Dezhi LI, Beijing (CN)

(21) Appl. No.: 15/069,045

(22) Filed: Mar. 14, 2016

(30) Foreign Application Priority Data
Jun. 24, 2015 (CN) 201510354188.4

(51) Int. Cl. H04L 29/06; H04L 9/32; G07C 9/00

(52) U.S. Cl. CPC H04L 63/0815; G07C 9/00142; H04L 9/321; H04L 63/0846

(57) ABSTRACT

Embodiments of the disclosure provide a method and apparatus for identity authentication between systems. The method includes: determining, by an authorization center, whether a user can be authorized to log onto a first system upon reception of a message, sent by the first system, of the user to request for logging onto the first system, and sending an encrypted information, into which user information of the user is encrypted, to the first system, upon determining that the user can log onto the first system; and upon reception of a message, sent by a second system, of the user to request for logging onto the second system, if the message carries the encrypted information, then decrypting, by the authorization center, the encrypted information in the case of the second system is determined as a trusted system of the first system, and returning the decrypted user information to the second system.

### CROSS-REFERENCE TO RELATED APPLICATIONS

This application claims the priority to Chinese Patent Application No. 201510354188.4, filed with the State Intellectual Property Office of People's Republic of China on Jun. 24, 2015 and entitled “Method and apparatus for identity authentication between systems”, the content of which is hereby incorporated by reference in its entirety.

### FIELD

The present disclosure relates to the field of communications, and particularly to a method and apparatus for identity authentication between systems.

### BACKGROUND

Identity authentication, also referred to as identity verification or identity identification, refers to a process in which the identity of a user is ascertained in a computer and a network system of the computer to determine whether the user can access to and utilize some resource so as to enable an access strategy of the computer and the network system to be enforced reliably and effectively, to prevent an attacker from impersonating a legal user to access to the resource, to secure the system and data, and to grant a legal user to access to the resource.

At present a number of protocols have emerged, and a variety of applications have also been derived, in the field of identity authentication, where Single Sign-On refers to that the identity of the user authorized by any one of the systems can be identified by any one of the other systems.

However single sign-on in the prior art requires the respective systems to be in the same level-2 domain name range, for example, a.letv.com and b.letv.com are in the same level-2 domain name range, or requires a protocol to be agreed on in advance between the respective systems, to thereby enable single sign-on by the user, resulting in that every additional system has to be aware of the single sign-on authorization protocol agreed on in advance, which may discourage the system from being added and deleted.

### SUMMARY

Embodiments of the disclosure provide a method and apparatus for identity authentication between systems in order to implement an identity authentication of a user's logon between the systems by an authorization center to thereby secure the authorization process and avoid troublesome agreement in advance on a protocol between the respective systems, where the entire authorization process is performed by the authorization center so that the authorization protocol is transparent to the respective systems to thereby make it more convenient and rapid to add and delete the systems.

At the authorization center side, an embodiment of the disclosure provides a method for identity authentication between systems, the method including:
determining, by an authorization center, whether a user can be authorized to log onto a first system upon reception of a message, sent by the first system, of the user to request for logging onto the first system, and sending an encrypted information, into which user information of the user is encrypted, to the first system, upon determining that the user can log onto the first system; and
upon reception of a message, sent by a second system, of the user to request for logging onto the second system, if the message carries the encrypted information, then decrypting, by the authorization center, the encrypted information in the case of the second system is determined as a trusted system of the first system, and returning the decrypted user information to the second system, wherein the encrypted information is sent by the first system to the second system.

At the side of any of the systems, an embodiment of the disclosure provides a method for identity authentication between systems, the method including:
upon reception of a message of a user to request for logging, sending, by a first system, to an authorization center a message of the user to request for logging onto the first system, to request the authorization center to determine whether a user can be authorized to log onto the first system; and
storing, by the first system, encrypted information, sent by the authorization center, into which the authorization center encrypts information of the user, upon reception of the encrypted information; and sending the encrypted information to a second system upon reception of a request of the user for logging onto the second system.

In correspondence to the method at the authorization center side, an embodiment of the disclosure provides an apparatus at the authorization center side for identity authentication between systems, the apparatus including:
one or more processor; and
a memory, wherein:
one or more computer readable program codes are stored in the memory, and the one or more processors are configured to perform the one or more computer readable program codes to perform:
determining whether a user can be authorized to log onto a first system upon reception of a message, sent by the first system, of the user to request for logging onto the first system, and sending an encrypted information, into which user information of the user is encrypted, to the first system, upon determining that the user can log onto the first system; and
upon reception of a message, sent by a second system, of the user to request for logging onto the second system, if the message carries the encrypted information, decrypting the encrypted information in the case of the second system is determined as a trusted system of the first system, and returning the decrypted user information to the second system, wherein the encrypted information is sent by the first system to the second system.

In correspondence to the method at the side of any one of the systems, an embodiment of the disclosure provides an apparatus at the side of any one of the systems for identity authentication between systems, the apparatus including:
one or more processor; and
a memory, wherein:
one or more computer readable program codes are stored in the memory, and the one or more processors are configured to perform the one or more computer readable program codes to perform:
upon reception of a message of a user to request for logging, sending to an authorization center a message of the user to request for logging onto a first system, to request the authorization center to determine whether a user can be authorized to log onto the first system; and
storing encrypted information, sent by the authorization center, into which the authorization center encrypts information of the user, upon reception of the encrypted information; and sending the encrypted information to a second system upon reception of a request of the user for logging onto the second system.

In the method and apparatus for identity authentication between systems according to the embodiments of the disclosure, the authorization center determines whether a user can be authorized to log onto the first system upon reception of the message, sent by the first system, of the user to request for logging onto the first system, and sends the encrypted information, into which the user information of the user is encrypted, to the first system, upon determining that the user can log onto the first system; and upon reception of the message, sent by the second system, of the user to request for logging onto the second system, if the message carries the encrypted information, then the authorization center decrypts the encrypted information in the case of the second system is determined as a trusted system of the first system, and returns the decrypted user information to the second system, where the encrypted information is sent by the first system to the second system, so that the authorization center can perform identity authentication of the user logging between the systems to thereby secure the authorization process and avoid troublesome agreement in advance on a protocol between the respective systems; and the entire authorization process is performed by the authorization center so that the authorization protocol is transparent to the respective systems to thereby make it more convenient and rapid to add and delete the systems.

### BRIEF DESCRIPTION OF THE DRAWINGS

In order to make the technical solutions in the embodiments of the disclosure or the prior art more apparent, the drawings to which the embodiments or the prior art are described with reference will be briefly introduced below, and apparently the drawings to be described below are merely illustrative of some of the embodiments of the disclosure, and other drawings can be derived from these drawings by those ordinarily skilled in the art without any inventive effort. In the drawings:

FIG. 1 is a schematic flow chart of a method at the authorization center side for identity authentication between systems according to an embodiment of the disclosure;

FIG. 2 is a schematic flow chart of a method at the system side for identity authentication between systems according to an embodiment of the disclosure;

FIG. 3 is a schematic flow chart of registering a system A with an authorization center according to an embodiment of the disclosure;

FIG. 4 is a schematic flow chart of registering a system B with an authorization center according to an embodiment of the disclosure;

FIG. 5 is a schematic flow chart of binding the system A and the system B as trusted systems at the authorization center according to an embodiment of the disclosure;

FIG. 6 is a timing diagram of a user logging onto the system A and jumping to the system B according to an embodiment of the disclosure;

FIG. 7 is a schematic structural diagram of an apparatus at the authorization center side for identity authentication between systems according to an embodiment of the disclosure; and

FIG. 8 is a schematic structural diagram of an apparatus at the system side for identity authentication between systems according to an embodiment of the disclosure;

FIG. 9 illustrates a schematic diagram of an apparatus at the authorization center side for identity authentication between systems according to an embodiment of the present disclosure;

FIG. 10 illustrates a schematic diagram of an apparatus at the side of any one of the systems for identity authentication between systems according to an embodiment of the present disclosure.

### DETAILED DESCRIPTION OF THE EMBODIMENTS

In order to make the objects, the technical solutions according to the embodiments of the disclosure and their advantages more apparent, the technical solutions according to the embodiments of the disclosure will be described clearly and fully with reference to the drawings in the embodiments of the disclosure. Apparently the described embodiments are only a part but all of the embodiments of the disclosure. Based upon the embodiments here of the disclosure, all of other embodiments derived by those ordinarily skilled in the art without any inventive effort shall come into the scope of the disclosure.

The technical solutions according to the embodiments of the disclosure relate to entities at two sides, which are an authorization center and systems respectively, where the authorization center can be a separate server at the network side, or a user equipment at the terminal side; and the respective systems can also be separate servers at the network side, or different application systems on a server, or different applications running on terminal devices including handsets, computers or PADs, or systems composed of terminal devices and remote servers. Before logging onto the systems, users need to register usernames, passwords, etc., with the systems, and to send registration information to the authorization center for storage. The entities at the respective sides can interact with each other in a wired or wireless manner. The systems as referred to in the embodiments of the disclosure are systems accessed by the really logging user, which can be horizontally scaled, that is, the number of systems can be expanded freely, for example, from two systems to more than two systems. The authorization center is a hub connecting the systems, and all users log onto the respective systems through the authorization center. The authorization center stores the usernames, the passwords, and other information required for authorization, of the user; and also stores information about the respective systems connected with the authorization center.

The technical solutions according to the embodiments of the disclosure will be described below with reference to the drawings.

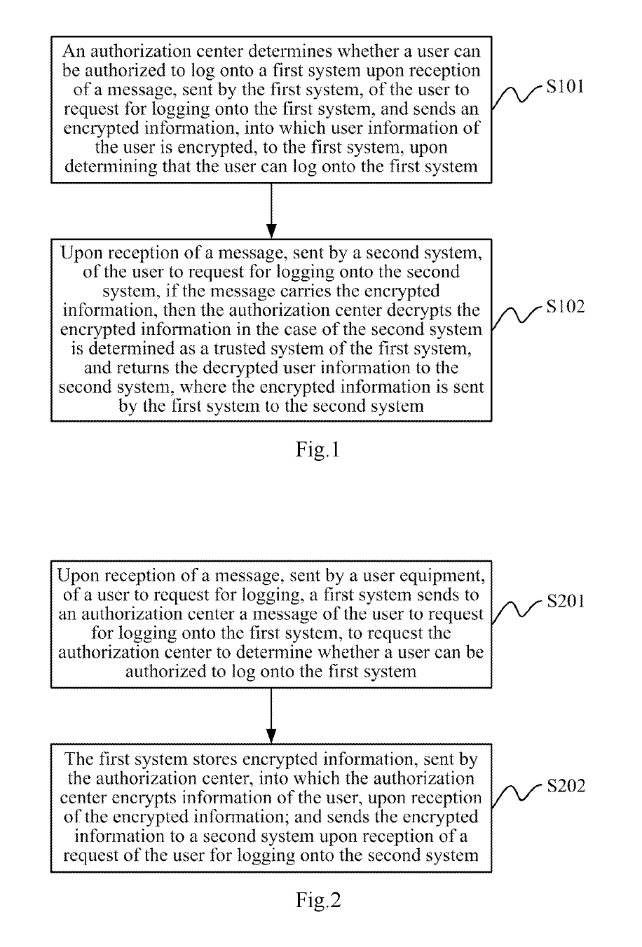

Referring to FIG. 1, at the authorization center side, a method for identity authentication between systems according to an embodiment of the disclosure includes:

S101. An authorization center determines whether a user can be authorized to log onto a first system upon reception of a message, sent by the first system, of the user to request for logging onto the first system, and sends encrypted information, into which user information of the user is encrypted, to the first system, upon determining that the user can log onto the first system;

The user as referred to throughout the embodiment of the disclosure can be understood as the same user.

S102. Upon reception of a message, sent by a second system, of the user to request for logging onto the second system, if the message carries the encrypted information, then the authorization center decrypts the encrypted information in the case of the second system is determined as a trusted system of the first system, and returns the decrypted user information to the second system, where the encrypted information is sent by the first system to the second system.

It shall be noted that the first system and the second system as referred to in the embodiment of the disclosure are only distinguished from each other as different systems, and the technical solution according to the embodiment of the disclosure will not be limited to a scenario in which there are only two systems, but can be equally applicable to a scenario in which there are more than two systems.

With this method, the authorization center determines whether a user can be authorized to log onto the first system upon reception of the message, sent by the first system, of the user to request for logging onto the first system, and encrypts the user information of the user into the encrypted information and sends the encrypted information to the first system upon determining that the user can log onto the first system, where the encrypted information carries an indicator that the user logs onto the first system, so that a system receiving the encrypted information can determine from the encrypted information that the encrypted information is encrypted information corresponding to the first system. Upon reception of the message, sent by the second system, of the user to request for logging onto the second system, if the message carries the encrypted information, then the authorization center decrypts the encrypted information into the user information in the case of the second system is determined as a trusted system of the first system, and returns the decrypted user information to the second system, so that the authorization center can perform identity authentication of the user logging between the systems to thereby secure the authorization process and avoid troublesome agreement in advance on a protocol between the respective systems; and the entire authorization process is performed by the authorization center so that the authorization protocol is transparent to the respective systems to thereby make it more convenient and rapid to add and delete the systems.

Optionally, before the authorization center receives the message, sent by the first system, of the user to request for logging onto the first system, the method further includes:

The authorization center registers the first system and the second system respectively, and generates a private key and a public key of the first system when the first system is registered successfully; and generates a private key and a public key of the second system when the second system is registered successfully.

Optionally the authorization center encrypts the user information using the private key of the first system, and decrypts the encrypted information using the public key of the first system.

Of course, alternatively the keys corresponding to the respective systems can be created in other ways for identity authentication between the systems.

Optionally after the authorization center registers the first system and the second system respectively, and before the authorization center receives the message, sent by the first system, of the user to request for logging onto the first system, the method further includes:

The authorization center creates a binding relationship between the first system and the second system upon reception of requests sent by the first system and the second system respectively for creating a trusted relationship with the each other.

Of course, alternatively the binding relationship between the first system and the second system can be created in other ways, for example, one or more binding relationship lists can be created in advance in the authorization center, where respective systems indicated in each of the lists are trusted systems of each other.

Optionally the authorization center determines from the binding relationship that the second system and the first system are trusted systems of each other.

Optionally the authorization center determining whether a user can be authorized to log onto the first system sends the user information of the user, and the encrypted information into which the user information is encrypted, to the first system upon determining that the user can log onto the first system, particularly as follows:

The authorization center sends a temporary username (client_id) and a temporary password (client_secret) to the first system upon determining that both a logon name and a password of the user are correct;

The authorization center sends an authorization code (authorization_code) to the first system upon reception of a request of the first system for the authorization code using the temporary username;

The authorization center sends an access token (access_token) to the first system upon reception of a request of the first system for the access token using the temporary username, the temporary password, and the authorization code; and

The authorization center sends the user information of the user, and the encrypted information into which the user information is encrypted, to the first system upon reception of the access token sent by the first system.

Optionally the encrypted information further includes information about the time when the user logs onto the first system (i.e., a timestamp); and

The authorization center decrypts the encrypted information sent by the second system upon reception of the encrypted information, and returns the user information into which the encrypted information is decrypted, to the second system upon determining from the information, into which the encrypted information is decrypted, about the time when the user logs onto the first system, that a preset period of time for which the user has logged onto the first system does not expire.

Correspondingly referring to FIG. 2, at the side of any one of the systems, a method for identity authentication between systems according to an embodiment of the disclosure includes:

S201. Upon reception of a message, sent by a user equipment, of a user to request for logging, a first system sends to an authorization center a message of the user to request for logging onto the first system, to request the authorization center to determine whether a user can be authorized to log onto the first system;

Here the first system can receive the log-on request of the user in a number ways, for example:

The user initiates an operation in the first system, and the first system detects that the user has not logged, and jumps directly to the authorization system; or

The user does not initiate an operation in the first system, and jumps from the first system directly to the authorization system.

S202. The first system stores encrypted information, sent by the authorization center, into which the authorization center encrypts information of the user, upon reception of the encrypted information; and sends the encrypted information to a second system upon reception of a request of the user for logging onto the second system.

Optionally the second system sends the encrypted information sent by the first system, to the authorization center upon reception of the encrypted information; and receives a log-on result fed back by the authorization center.

In an embodiment of the disclosure, the first system and the second system can be software systems run by the same server, or can be software systems run by the same user equipment.

Optionally after the first system sends to the authorization center the message of the user to request for logging onto the first system, and before the first system receives the user information of the user, and the encrypted information, sent by the authorization center, the method further includes:

The first system receives a temporary username and a temporary password sent by the authorization center;

The first system requests, using the temporary username, the authorization center for sending an authorization code;

The first system requests, using the temporary username, the temporary password and the authorization code, the authorization center for sending an access token, upon reception of the authorization code sent by the authorization center; and

The first system requests, using the access token sent by the authorization center, the authorization center for sending the user information of the user, upon reception of the access token.

The technical solution according to the embodiments of the disclosure will be described below at the level of the entire architecture.

For the sake of conciseness, suppose there are currently two systems A and B in total, a user logs onto the system A, and the system B needs to know that the user has logged.

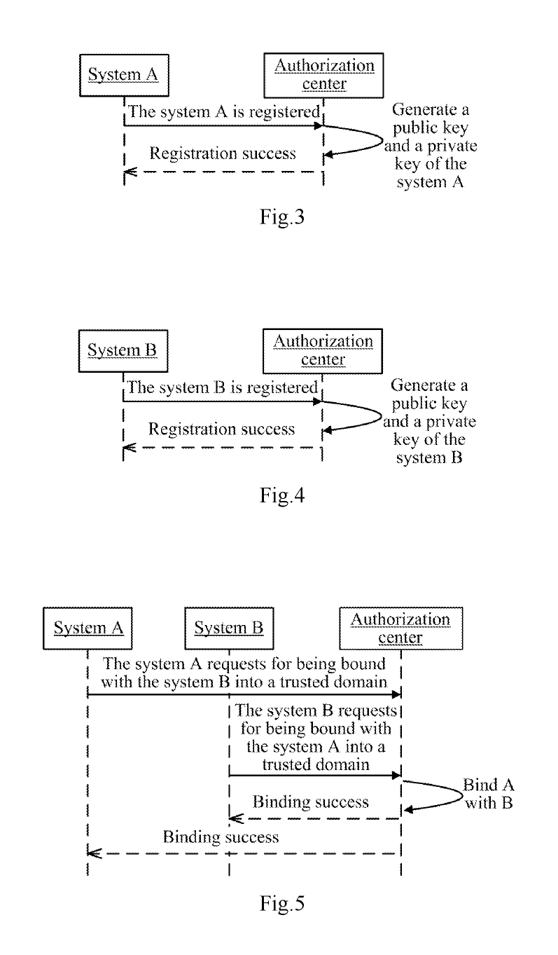

As illustrated in FIG. 3 and FIG. 4, the system A and the system B need to authorize the logging user for each other, where firstly the user A and the user B need to be registered respectively with an authorization center. As illustrated in FIG. 3, while the system A is being registered, the authorization center generates a public key and a private key of the system A, and notifies the system A of a registration success, where information of the user logging onto the system A is encrypted using the private key of the system A, and the user information is decrypted by the other trusted system (e.g., the system B) using the public key of the system A. As illustrated in FIG. 4, while the system B is being registered, the authorization center generates a public key and a private key of the system B, and notifies the system B of a registration success, where the information of the user logging onto the system B is encrypted using the private key of the system B, and the user information is decrypted by the other trusted system (e.g., the system A) using the public key of the system B.

It will not suffice only if the system A and the system B are registered with the authorization center, and as illustrated in FIG. 5, the system A and the system B further need to submit such a binding request that the authorization system attributes the system A and the system B into a trusted domain, so that the authorization center can decrypt the user information of the user using the public key of the opposite system only after the system A or the system B submits a request for decrypting the user information.

For the sake of security, the authorization center only accepts a Hypertext Transfer Protocol over Secure Socket Layer (https) request. User passwords are stored by the authorization center, and log-on requests of all the users are directed to the authorization center for processing. After the user logs successfully, the system retrieves the user information in the Open Authorization (OAUTH) protocol (the OAUTH protocol is a secured, open and simple standard to authorize a user resource).

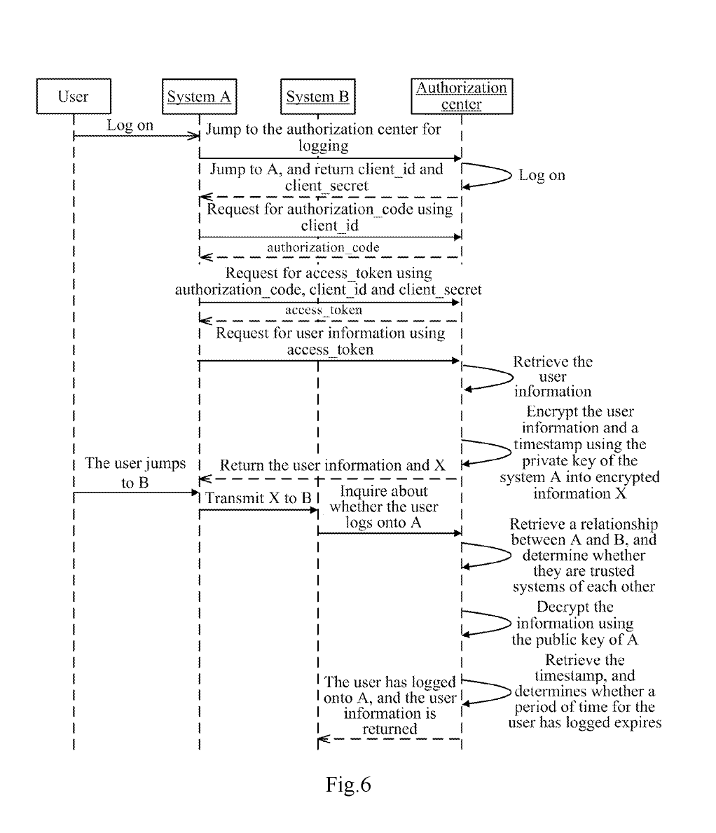

FIG. 6 illustrates the entire timing of the user logging onto the system A and jumping to the system B, and referring to FIG. 6, the general process particularly includes:

The user equipment initiates a user log-on request to the system A.

The user A sends the user log-on request carrying the username and the password as well as a redirected address (redirect_uri) to the authorization center, where redirect_uri is a domain name of the system A, indicating that the user log-on request comes from the system A.

The authorization center checks the username and the password upon reception of the user log-on request, and if they match, then the authorization center determines that the user logs on successfully, and generates a temporary client_id and client_secret as a temporary id and a temporary password of the user (so that the password of the user will not be revealed) to identify the user, and then notifies the system A based on the redirected address (redirect_uri) that the user logs successfully, where the notification further carries client_id and client_secret, which can be used as a temporary access id and access password of the system A (instead of returning the real user id and the password of the user).

As per the OAUTH protocol, the system A requests using client_id the authorization center for an authorization code (authorization_code);

The authorization center sends authorization_code to the system A according to client_id; and

The system A requests the authorization center for an access token (access_token), in an https request, using client_id, client_secret and authorization_code in a validity period of time of the authorization code (10 minutes by default, or setting in advance, for example, for a verification code in a short message for payment over the Internet), where the token access_token is returned to the system A in the json format (a data representation format) as a token for the system A to request for the user information.

Here client_id and client_secret are a temporary username and password for accessing the authorization system (instead of the real username and password without revealing any information), and authorization_code similar to a verification code remains valid only for a period of time, thus further securing this process.

The system A sends the token access_token to the authorization center; and

The authorization center retrieves the user information using access_token, where the user information includes: client_id and client_secret, the username, the gender of the user, a telephone number, an Email account, and other user attribute information.

The authorization center encrypts the user information and the current timestamp using the private key of the system A into encrypted information X, and returns the encrypted information X to the system A together with the user information.

The system A can process the user information and the encrypted information X in the following two approaches upon reception of them: in one approach, the system A sends the encrypted information X to the user equipment, and the user equipment stores the encrypted information X locally, and sends the encrypted information to the system B when the user is logging onto the system B; and in the other approach, the system A provides an access link of the system B, so that the user equipment can send a request for logging onto the system B, through the system A, and the system A sends the encrypted information X to the system B upon reception of the request for logging onto the system B.

FIG. 6 illustrates the user jumping to the system B, i.e., in the other approach, the user A provides the access link of the system B, and after the user clicks on the link, the user equipment can send a request for logging onto the system B, through the system A, and the system A sends the encrypted information X to the system B upon reception of the request for logging onto the system B, where the system A passes X to the system B in the form of parameters (which are prescribed across the respective systems that if the user jumps to a system, the parameters of X should be transmitted in an https request, and if the user does not log, then the parameters of X may be null).

The system B sends a request message to the authorization center to inquire about whether the user has logged onto the system A, upon reception of the encrypted information X; and the authorization center inquires about whether there is a binding relationship between the system A and the system B, upon reception of the request message, and if so, then the authorization center determines that the system A and the system B are trusted systems of each other, and then decrypts the encrypted information X using the public key of the system A into the user information and the timestamp, determines from the timestamp whether a period of time for which the user is logged onto the system A expires, and if not, then the authorization center sends the user information to the system B, and notifies the system B that the user has logged onto the system A.

Here the operation of determining from the timestamp whether the period of time for which the user has logged onto the system A expires is a preferable operation step but may not be necessary; and moreover the authorization center can further check the user information after decrypting the encrypted information into the user information, and if the user information into which the encrypted information is decrypted is consistent with the locally stored user information of the same user, the authorization center sends the user information to the system B, thus further guaranteeing the security of logging between the systems.

As can be apparent, the technical solutions according to the embodiments of the disclosure have the following several advantageous effects over the prior art:

With the https protocol, the passwords will not be revealed while being transmitted, and the passwords of the system are stored in the authorization center to thereby secure the authorization process;

The OAUTH protocol can be enforced in the form of a language kit, and the entire single sign-on authorization process is performed by the authorization center so that the authorization protocol is transparent to the systems; and

It will be easier to add and delete the systems, that is, the systems can be horizontally scaled.

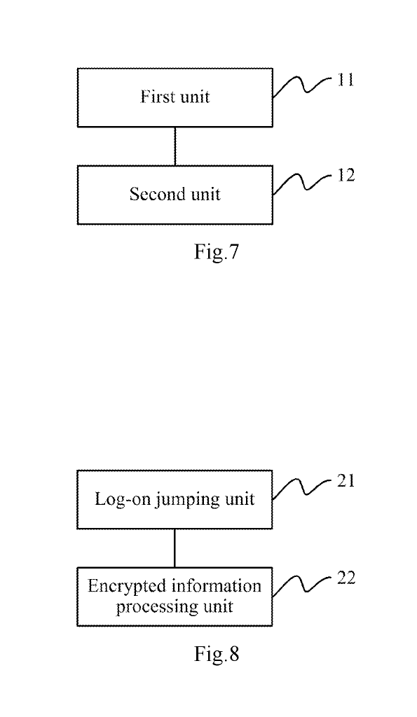

In correspondence to the method above at the authorization center side, referring to FIG. 7, an apparatus at the authorization center side for identity authentication between systems according to an embodiment of the disclosure includes:

A first unit 11 is configured to determine whether a user can be authorized to log onto a first system upon reception of a message, sent by the first system, of the user to request for logging onto the first system, and to send an encrypted information, into which user information of the user is encrypted, to the first system, upon determining that the user can log onto the first system; and

A second unit 12 is configured, upon reception of a message, sent by a second system, of the user to request for logging onto the second system, if the message carries the encrypted information, to decrypt the encrypted information in the case of the second system is determined as a trusted system of the first system, and to return the decrypted user information to the second system, where the encrypted information is sent by the first system to the second system.

Optionally the first unit is further configured, before the message, sent by the first system, of the user to request for logging onto the first system is received:

To register the first system and the second system respectively; and to generate a private key and a public key of the first system when the first system is registered successfully, and to generate a private key and a public key of the second system when the second system is registered successfully.

Optionally the first unit encrypts the user information using the private key of the first system, and the second unit decrypts the encrypted information using the public key of the first system.

Optionally the first unit is further configured, after the first system and the second system are registered respectively:

To create a binding relationship between the first system and the second system upon reception of requests sent by the first system and the second system respectively for creating a trusted relationship with each other.

Optionally the second unit is configured to determine from the binding relationship that the second system and the first system are trusted systems of each other.

Optionally the first unit is configured, after the message, sent by the first system, of the user to request for logging onto the first system is received:

To send a temporary username and a temporary password to the first system upon determining that both a logon name and a password of the user are correct;

To send an authorization code to the first system upon reception of a request of the first system for the authorization code using the temporary username;

To send an access token to the first system upon reception of a request of the first system for the access token using the temporary username, the temporary password, and the authorization code; and

To send the user information of the user, and the encrypted information into which the user information is encrypted, to the first system upon reception of the access token sent by the first system.

Optionally the encrypted information further includes time information for logging onto the first system; and

The second unit is configured, after the encrypted information is decrypted, to return the decrypted user information to the second system upon determining from the decrypted time information for logging onto the first system, that a preset period of time for which the user has logged onto the first system does not expire.

In correspondence to the method above at the side of any one of the systems, referring to FIG. 8, an apparatus at the side of any one of the systems for identity authentication between systems according to an embodiment of the disclosure includes:

A log-on jumping unit 21 is configured, upon reception of a message of a user to request for logging, to send to an authorization center a message of the user to request for logging onto a first system, to request the authorization center to determine whether a user can be authorized to log onto the first system; and

An encrypted information processing unit 22 is configured to store encrypted information, sent by the authorization center, into which the authorization center encrypts information of the user, upon reception of the encrypted information; and to send the encrypted information to a second system upon reception of a request of the user for logging onto the second system.

Optionally the encrypted information processing unit is further configured to send the encrypted information sent by the first system, to the authorization center when the second system receives the encrypted information; and to receive a log-on result fed back by the authorization center.

Optionally the log-on jumping unit is further configured, after the message of the user to request for logging onto the first system is sent to the authorization center:

To receive a temporary username and a temporary password sent by the authorization center;

To request, using the temporary username, the authorization center for sending an authorization code;

To request, using the temporary username, the temporary password and the authorization code, the authorization center for sending an access token, upon reception of the authorization code sent by the authorization center; and

To request, using the access token sent by the authorization center, the authorization center for sending the user information of the user, upon reception of the access token.

It shall be noted that any one of the units in the embodiments of the disclosure can be embodied as a hardware processor performing the related functions thereof.

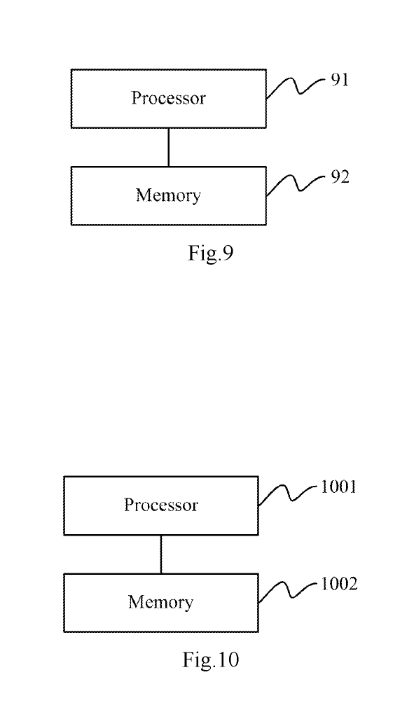

The relevant functional units illustrated in FIG. 7 can be embodied as a hardware processor in an embodiment of the disclosure. In a particular implementation, as illustrated in FIG. 9, there is a schematic diagram of an apparatus at the authorization center side for identity authentication between systems according to an embodiment of the present disclosure, which can include: one or more processor 91; and a memory 92, wherein: one or more computer readable program codes are stored in the memory, and the one or more processors are configured to perform the one or more computer readable program codes to perform: determining whether a user can be authorized to log onto a first system upon reception of a message, sent by the first system, of the user to request for logging onto the first system, and sending an encrypted information, into which user information of the user is encrypted, to the first system, upon determining that the user can log onto the first system; and upon reception of a message, sent by a second system, of the user to request for logging onto the second system, if the message carries the encrypted information, then decrypting the encrypted information in the case of the second system is determined as a trusted system of the first system, and returning the decrypted user information to the second system, wherein the encrypted information is sent by the first system to the second system.

Optionally before the message, sent by the first system, of the user to request for logging onto the first system is received, the one or more processors are further configured to perform the one or more computer readable program codes to perform: registering the first system and the second system respectively; and generating a private key and a public key of the first system when the first system is registered successfully, and generating a private key and a public key of the second system when the second system is registered successfully; and wherein the user information is encrypted using the private key of the first system, and the encrypted information is decrypted using the public key of the first system.

Optionally after the first system and the second system are registered respectively, the one or more processors are further configured to perform the one or more computer readable program codes to perform: creating a binding relationship between the first system and the second system upon reception of requests sent by the first system and the second system respectively for creating a trusted relationship with each other.

Optionally the one or more processors are further configured to perform the one or more computer readable program codes to perform: determining from the binding relationship that the second system and the first system are trusted systems of each other.

Optionally the encrypted information further comprises time information for logging onto the first system; and the one or more processors are further configured to perform the one or more computer readable program codes to perform: after the encrypted information is decrypted, returning the decrypted user information to the second system upon determining from the decrypted time information for logging onto the first system, that a preset period of time for which the user has logged onto the first system does not expire.

The relevant functional units illustrated in FIG. 8 can be embodied as a hardware processor in an embodiment of the disclosure. In a particular implementation, as illustrated in FIG. 10, there is a schematic diagram of an apparatus at the side of any one of the systems for identity authentication between systems according to an embodiment of the present disclosure, which can include: one or more processor 1001; and a memory 1002, wherein: one or more computer readable program codes are stored in the memory, and the one or more processors are configured to perform the one or more computer readable program codes to perform: upon reception of a message of a user to request for logging, sending to an authorization center a message of the user to request for logging onto a first system to request the authorization center to determine whether a user can be authorized to log onto the first system; and storing encrypted information, sent by the authorization center, into which the authorization center encrypts information of the user, upon reception of the encrypted information; and sending the encrypted information to a second system upon reception of a request of the user for logging onto the second system.

Optionally the one or more processors are further configured to perform the one or more computer readable program codes to perform: sending the encrypted information sent by the first system, to the authorization center when the second system receives the encrypted information; and receiving a log-on result fed back by the authorization center.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those skilled in the art can clearly appreciate from the foregoing description of the embodiments that the embodiments of the disclosure can be implemented in hardware or in software plus a necessary general hardware platform. Based upon such understanding, the technical solutions above essentially or their parts contributing to the prior art can be embodied in the form of a computer software product which can be stored in a computer readable storage medium, e.g., an ROM/RAM, a magnetic disk, an optical disk, etc., and which includes several instructions to cause a computer device (e.g., a personal computer, a server, a network device, etc.) to perform the method according to the respective embodiments of the disclosure.

Lastly it shall be noted that the embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof;

and these modifications or substitutions to the corresponding technical solution shall also fall into the scope of the disclosure as claimed.

1. A method for identity authentication between systems, the method comprising:
determining, by an authorization center, whether a user can be authorized to log onto a first system upon reception of a message, sent by the first system, of the user to request for logging onto the first system, and sending an encrypted information, into which user information of the user is encrypted, to the first system, upon determining that the user can log onto the first system; and
upon reception of a message, sent by a second system, of the user to request for logging onto the second system, if the message carries the encrypted information, decrypting, by the authorization center, the encrypted information in the case of the second system is determined as a trusted system of the first system, and returning the decrypted user information to the second system, wherein the encrypted information is sent by the first system to the second system.

2. The method according to claim 1, wherein before the authorization center receives the message, sent by the first system, of the user to request for logging onto the first system, the method further comprises:
registering, by the authorization center, the first system and the second system respectively; and generating a private key and a public key of the first system when the first system is registered successfully, and generating a private key and a public key of the second system when the second system is registered successfully; and
wherein the user information is encrypted by the authorization center using the private key of the first system, and the encrypted information is decrypted by the authorization center using the public key of the first system.

3. The method according to claim 2, wherein after the authorization center registers the first system and the second system respectively, the method further comprises:
creating, by the authorization center, a binding relationship between the first system and the second system upon reception of requests sent by the first system and the second system respectively for creating a trusted relationship with each other.

4. The method according to claim 3, wherein the authorization center determines from the binding relationship that the second system and the first system are trusted systems of each other.

5. The method according to claim 1, wherein the encrypted information further comprises time information for logging onto the first system; and
after the encrypted information is decrypted, the authorization center returns the decrypted user information to the second system upon determining from the decrypted time information for logging onto the first system, that a preset period of time for which the user has logged onto the first system does not expire.

6. A method for identity authentication between systems, the method comprising:
upon reception of a message of a user to request for logging, sending, by a first system, to an authorization center a message of the user to request for logging onto the first system, to request the authorization center to determine whether a user can be authorized to log onto the first system; and
storing, by the first system, encrypted information, sent by the authorization center, into which the authorization center encrypts information of the user, upon reception of the encrypted information; and sending the encrypted information to a second system upon reception of a request of the user for logging onto the second system.

7. The method according to claim 6, wherein after the encrypted information sent by the first system is received, the second system sends the encrypted information to the authorization center and receives a log-on result fed back by the authorization center.

8. An apparatus for identity authentication between systems, the apparatus comprising:
one or more processor; and
a memory, wherein:
one or more computer readable program codes are stored in the memory, and the one or more processors are configured to perform the one or more computer readable program codes to perform:
determining whether a user can be authorized to log onto a first system upon reception of a message, sent by the first system, of the user to request for logging onto the first system, and sending an encrypted information, into which user information of the user is encrypted, to the first system, upon determining that the user can log onto the first system; and
upon reception of a message, sent by a second system, of the user to request for logging onto the second system, if the message carries the encrypted information, decrypting the encrypted information in the case of the second system is determined as a trusted system of the first system, and returning the decrypted user information to the second system, wherein the encrypted information is sent by the first system to the second system.

9. The apparatus according to claim 8, wherein before the message, sent by the first system, of the user to request for logging onto the first system is received, the one or more processors are further configured to perform the one or more computer readable program codes to perform:
registering the first system and the second system respectively; and generating a private key and a public key of the first system when the first system is registered successfully, and generating a private key and a public key of the second system when the second system is registered successfully; and
wherein the user information is encrypted using the private key of the first system, and the encrypted information is decrypted using the public key of the first system.

10. The apparatus according to claim 9, wherein after the first system and the second system are registered respectively, the one or more processors are further configured to perform the one or more computer readable program codes to perform:
creating a binding relationship between the first system and the second system upon reception of requests sent by the first system and the second system respectively for creating a trusted relationship with each other.

11. The apparatus according to claim 10, wherein the one or more processors are further configured to perform the one or more computer readable program codes to perform:
determining from the binding relationship that the second system and the first system are trusted systems of each other.

12. The apparatus according to claim 8, wherein the encrypted information further comprises time information for logging onto the first system; and
the one or more processors are further configured to perform the one or more computer readable program codes to perform:
after the encrypted information is decrypted, returning the decrypted user information to the second system upon determining from the decrypted time information for logging onto the first system, that a preset period of time for which the user has logged onto the first system does not expire.

13. An apparatus for identity authentication between systems, the apparatus comprising:
one or more processor; and
a memory, wherein:
one or more computer readable program codes are stored in the memory, and the one or more processors are configured to perform the one or more computer readable program codes to perform:
upon reception of a message of a user to request for logging, sending to an authorization center a message of the user to request for logging onto a first system to request the authorization center to determine whether a user can be authorized to log onto the first system; and
storing encrypted information, sent by the authorization center, into which the authorization center encrypts information of the user, upon reception of the encrypted information; and
sending the encrypted information to a second system upon reception of a request of the user for logging onto the second system.

14. The apparatus according to claim 13, wherein the one or more processors are further configured to perform the one or more computer readable program codes to perform:
sending the encrypted information sent by the first system, to the authorization center when the second system receives the encrypted information; and receiving a log-on result fed back by the authorization center.
